(19) United States
(12) Patent Application Publication
(10) Pub. No.: US 2015/0100646 A1
(43) Pub. Date: Apr. 9, 2015

(54) SYSTEM AND METHOD FOR MESSAGE SERVICE PROVISION

(71) Applicant: PREFRR INC., Toronto (CA)

(72) Inventor: Safiq LAVJI, North York (CA)

(73) Assignee: PREFRR INC., Toronto (CA)

(21) Appl. No.: 14/224,538

(22) Filed: Mar. 25, 2014

Related U.S. Application Data
(60) Provisional application No. 61/888,311, filed on Oct. 8, 2013.

(51) Int. Cl. H04L 12/58

(52) U.S. Cl. CPC H04L 51/04
USPC 709/206

(57) ABSTRACT

A system and method for providing a message at a computing device is provided. A message content originating at a provisioning server is received, the message content being selected based on a messaging campaign associated with a user account maintained at the provisioning server. The message content is provided in association with user account participation at a first network service, the network service being provided by a service server different from a provisioning server. The participation can take the form of an activity comprising posting an entry in the form of at least one of: an update, a comment, a blog, a chat entry, a feed entry and a short entry. Providing the message can further comprise displaying a message indicator on or near the activity, detecting an interaction with the message indicator, and is playing the message content when an interaction is detected.

### RELATED APPLICATIONS

This application claims priority from U.S. patent application 61/888,311, filed Oct. 8, 2013. Priority is claimed to this earlier filed application and the contents of this earlier filed application is incorporated herein, in its entirety, by reference.

### FIELD OF INVENTION

The present invention relates generally to messaging, and more particularly to a system and method for message provisioning service.

### BACKGROUND

Various forms of processes exist for distribution of messages. Specifically, existing messaging provisioning services typically provision advertising messages to be placed in web pages or on portions of the display of applications such as an email application or a free mobile app. These messages are typically provisioned a certain number of times and without regard to the users. Some attempts are made to provide messages that are relevant to users and their activities. For example, messages can be provided which are associated with a search keyword or keywords identified in the subject of an email. However, the messages receive no vetting or approval by a user before being provisioned.

### SUMMARY

It is an objective to provide a novel system and method for displaying layered images that obviates and mitigates at least one of the above-identified disadvantages of the prior art.

According to an aspect, a method of providing a message at a computing device is provided. The method can comprise:
receiving a message content originating at a provisioning server, the message content being selected based on a messaging campaign associated with a user account maintained at the provisioning server; and providing the message content in association with user account participation at a first network service, the network service being provided by a service server different from a provisioning server.

The participation can be an activity comprising posting an entry in the form of at least one of: an update, a comment, a blog, a chat entry, a feed entry and a short entry. The message content can be provided by a business account different from the user account.

Providing can further comprise:
displaying a message indicator on or near the activity;
detecting an interaction with the message indicator; and
displaying the message content when an interaction is detected.

Providing the message content can further comprise displaying the message content in or within the vicinity of the entry associated with the activity. Providing the message content can further comprise substituting an account indicator associated with the activity with at least a portion of the message content. The participation can be a network service presence including a web page or a user account home page for the network service. The association of the messaging campaign with the user account can be based on a user profile specified by the user account, the user profile including at least one of categories, services information and user compensation information. The categories can be determined based on category information generated in association with past participation, by the user account, in a plurality of network services. Receiving the message content can include an indication of endorsement.

According to another aspect, a method of message provisioning by a provisioning server is provided. The method can comprise:
maintaining user account profiles associated with user accounts;
maintaining campaign service requirements and messages associated with a messaging campaign;
selecting an included user account from the user accounts, and an included network service, the selection being based on the campaign service requirements and the user account profiles; and
associating the included user account and the included network service with the messaging campaign.

The method message provisioning can further comprise transmitting at least a subset of the messages for provision in association with a participation of the included user account with the included network service. Participation can be at least one of activity or presence at the included network services.

The method of message provisioning can further comprise:
selecting the subset of the messages based on an included user account profile associated with the included user account; and
associating the subset of the messages with the selected user account and the selected network service.

The included user account profile associated with the included user account selected can include categories, the method further comprising:
receiving category information generated in association with a participation, by the included user account, in a plurality of network services; and
updating the categories based on the received category information.

The included user account profile associated with the included user account selected can include compensation requirements, and the method of message provisioning can further comprise:
providing compensation to the included user account after a compensation criteria is met.

The compensation criteria can be based on the number and type of messages provided in association with the included user account. The method of message provisioning can further comprise:
sending an endorsement request to said included user account;
receiving approval of said endorsement request; and
including and indication of endorsement as part of the transmitted messages.

According to a further aspect, a provisioning server is provided. The provisioning server can comprise:
a storage device maintaining user account profiles associated with user accounts, the storage device further maintaining campaign service requirements and messages associated with a campaign service; a communication interface;
a processor connected to said storage device for accessing contents of said storage device, the processor also connected to said network interface for receiving and transmitting communications, the processor further configured for:
selecting an included user account from the user accounts, and an included network service, the selection being based on the campaign service requirements and the user account profiles; and associating the included user account and the included network service with the campaign service.

### BRIEF DESCRIPTION OF DRAWINGS

FIG. 1 shows a block diagram of an implementation of a system for message provision service;

FIG. 2 shows a method of account data management;

FIG. 3 shows a block diagram of a user interface in accordance with an implementation;

FIG. 4 shows a method of message provisioning;

FIG. 5 shows a block diagram of a user interface in accordance with an implementation;

FIG. 6 shows a method of message blocking in accordance with an implementations;

FIG. 7 shows a block diagram of a user interface in accordance with an implementation; and

FIG. 8 shows a block diagram of a user interface in accordance with an implementation.

### DETAILED DESCRIPTION

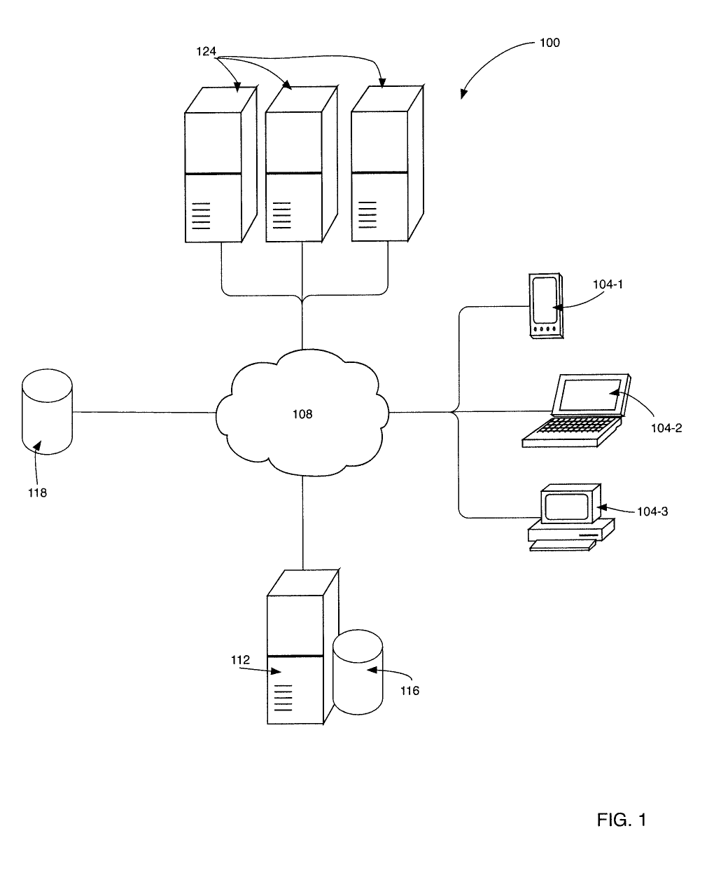

FIG. 1 shows a diagram of a system 100 for message provisioning. At least one client terminal (client terminals 104-1, 104-2 and 104-3) can be connected, via network 108, to a provisioning server 112. Collectively, client terminals 104-1, 104-2 and 104-3 are referred to as client terminals 104, and generically as client terminal 104. This nomenclature is used elsewhere herein.

Client terminals 104 can be based on any suitable computing environment, and the type is not particularly limited so long as each client terminal 104 is capable of receiving data from the provisioning server 112, displaying data in graphical form and transmitting data to the provisioning server 112. In a present implementation, client terminals 104 are configured to at least execute a web browser that can interact with the web service hosted by the provisioning server 112. In other implementations a client terminal 104 may be able to execute applications, widgets and other executables that will now occur to a person of skill in the art.

In specific implementations, client terminals 104 can be based on any type of client computing environment, such as a desktop computer, a laptop computer, a netbook, a tablet, a smart phone, a PDA, other mobile computing device or any other platform suitable for graphical display that is known in the art. For example, client terminal 104, in various implementations take the form of a smart TV, digital displays, electronic eyewear, watches, digital billboards of any size, wearable technology such as glass, computing environments in refrigerators and cars, other embedded computers and other forms that will now occur to a person of skill. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one implementation, memory includes both a non-volatile memory for persistent storage computer-readable instructions and other data, and a non-volatile memory for short-term storage of such computer-readable instructions and other data during the execution of the computer-readable instructions. Other types of computer readable storage medium, which in some implementations may be removable or external to client terminal 104 are also contemplated, such as secure digital (SD) cards and variants thereof. Other examples of external or removable computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 104 can include additional input devices in the form of one or more additional buttons, light sensors, microphones and the like. More generally, any suitable combination of the above-mentioned input devices can be incorporated into client terminal 104.

Client terminals 104 can further include one or more output devices. The output devices of client terminal 104 can include a display. When the pointing device includes a touchscreen, the touchscreen can be integrated with the display. Each client terminal 104 can also include a communications interface operably connected to the processor. The communications interface can allow a client terminal 104 to communicate with other computing devices, for example via network 108. The communications interface can therefore be selected for compatibility with network 108. In other implementations of system 100, client terminals 104 may be connected to provisioning server 112 directly without an intervening network 108 such as where the client terminal 104 is connected to provisioning server 112 through a wired universal serial bus (USB) connection or a wireless Bluetooth connection. These connections can be established in addition to or in place of a connection through a network.

Network 108 can comprise any network capable of linking provisioning server 112 with client terminals 104 and can include any suitable combination of wired and/or wireless networks, including but not limited to a Wide Area Network (WAN) such as the Internet, a Local Area Network (LAN), cell phone networks, WiFi networks, WiMax networks and the like.

In general terms, provisioning server 112 can comprise any platform capable of processing, transmitting, receiving, and storing data. In a present embodiment, provisioning server 112 is a server configured for providing a centralized messaging service. provisioning server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage. Provisioning server 112 can also include one or more network interfaces, to connect to network 108 or client terminal 104. Provisioning server 112 can also be configured to include input devices such as a keyboard or pointing device or output devices such as a monitor or a display or any of or all of them, to permit local interaction.

Other types of hardware configurations for provisioning server 112 are contemplated. For example, provisioning server 112 can also be implemented as part of a cloud-based computing solution, whereby the functionality of provisioning server 112 is implemented as one or more virtual machines executing at a single data center or across a plurality of data centers. Provisioning server 112 can also be implemented as a distributed server, distributed across multiple computing devices operably connected across a network, including network 118. The software aspect of the computing environment of provisioning server 112 can also include remote access capabilities in lieu of, or in addition to, any local input devices or local output devices.

Any desired or suitable operating system can be used in the computing environment of provisioning server 112. The computing environment can be accordingly configured with appropriate operating systems and applications to effect the functionality discussed herein. Those of skill in the art will now recognize that provisioning server 112 need not necessarily be implemented as a stand-alone device and can be integrated as part of a multi-purpose server or implemented entirely in software, for example a virtual machine.

In the present example implementation, provisioning server 112 can maintain at least one data-store 120. Data-store 120 (not shown) can be maintained on a storage so device integral to or attached to provisioning server 112, as shown at 116, or can be stored at a remote storage facility such as a network attached storage (NAS) device or at a cloud based storage (118) or a combination of these storage options. A storage device can be a hard-disk drive, solid-state drive, or any other type and arrangement of non-volatile and or volatile storage device. Data-stores 120 can be implemented using a variety of constructs including linked lists, arrays, object oriented containers, relational or flat databases, trees, graphs or recursive structures amongst others. Moreover, each Data-store 120 can be organized in a different manner from other data stores 120. Variations in the organization of the information in a data store 120 will now occur to one of skill in the art, all of which are contemplated as possible implementations of data storage and are considered within scope.

System 100 can also include one or more service servers 124. Broadly speaking, a service server 124 can be any server that is operable to provide one or more services, such as web services, social network services such as Facebook™ Google™, Twitter™ or LinkedIn™ and other networked data services such as serving web sites, e-commerce sites, blog sites, Internet radio and video, personal information management (PIM) services such as email, calendar and contacts services and others that will now occur to a person of skill. Service servers 124 can also include advertising servers, which provide messages and content. Accordingly, in one implementation, provisioning server 112 can obtain messages from one or more advertising service servers 124 to provide to other service servers 124 such as social networking services. A service server 124 may communicate with one or more other service servers 124 and other servers (not shown) to perform one or more of its functions. For example, an e-commerce server 124 may link with one or more other servers or devices, such as warehouse servers, payment processing servers, and the like. And advertising server may communicate with an advertising network for the selection and provision of messages. As with provisioning server 112, service servers 124 can be implemented using various types of hardware and/or software configurations, all of which are contemplated.

Variations in the implementation of system 100 will now occur to one of skill in the art, all of which are contemplated as possible implementations of system 100 and are considered within scope. For example, in some variations, one or more service servers 124, providing network services, can also perform the functionality of the provisioning server 112, precluding the need for a separate provisioning server 112.

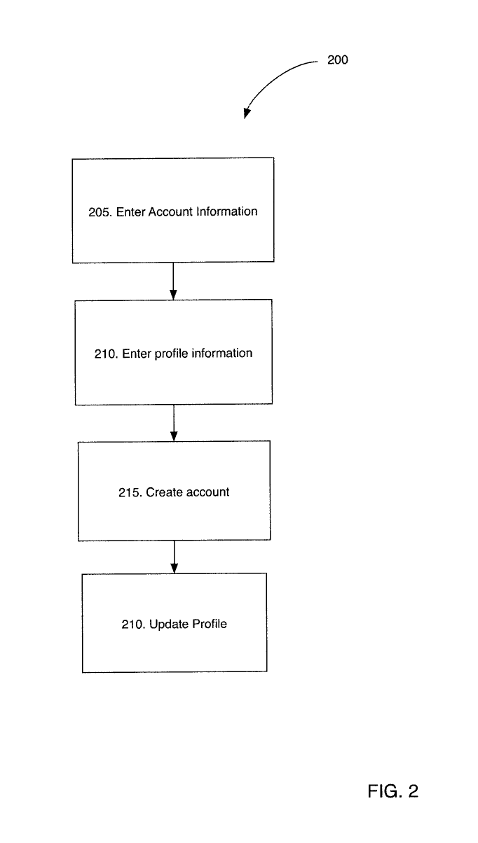

Referring now to FIG. 2, a method of account data management is indicated generally at 200. In order to assist in the explanation of the method, it'll be assumed that method 200 is operated using system 100 as shown in FIG. 1. Additionally, the following discussion of method 200 leads to further understanding of system 100. However, it is to be understood that system 100, and method 200 can be varied, and need not work exactly as discussed herein in conjunction with each other, and that such variations are within scope.

Beginning at 205, user account information is provided. A user account allows clients 104 to access the features and/or functions of provisioning server 112. In one implementation a user account can be accessed using a client terminal 104, which can communicate with provisioning server 112 through the network 108. For example, client terminal 104-3, a desktop computer, could obtain a web page provided by provisioning server 112, the web page designed to acquire and forward to provisioning server 112 information necessary for creating or updating a user account. In variations, communication with provisioning server 112 can be implemented differently. For example, a client terminal 104 can communicate with provisioning server 112 through an application executing on client terminal 104 which can access network 108. Accordingly, user account information can be received through the application executing on the client terminal 104-3 and communicated to provisioning server 112 by the application. In some implementations, provisioning server 112 may provide specific APIs and/or interface for communicating with provisioning server 112 for maintaining a user account. Other methods of communicating with provisioning server 112 to provide and receive user account information will now occur to a person of skill in the art and such methods are contemplated. User account information can include a username, a password, user account type information and/or other information that will now occur to a person of skill.

Continuing with method 200 at step 210, user profile information is provided. The user profile information may be used in determining the features and/or functions of provisioning server 112 that can be accessed by or applied to an associated user account. User profile information can be information that is maintained in any modality such as text, audio, video and the like.

User profile information can be categorized. For example, user profile information can include categories such as “like”, “dislike” and “endorse”. Category “like” can indicate, for example, subject matter such as products, places, people and movies that the user account holder likes and prefers to be associated with. Category “dislike” can indicate subject matter such as products, places, people and movies that the account holder dislikes and with which the account holder prefers not to be associated. As non-limiting examples, information categorized as “like” can include alternative rock, concerts, the band Alty, and cars and dislikes can include opera, swimming and expensive gadgets. Category endorse can indicate that the user account has provided or does provide positive feedback regarding the particular information categorized as “endorse”.

User profile information can also include services information, including an indication of network services that a user account is associated with and/or is a member of. In a non-limiting example, network services can include social networks such as Facebook™, product review sites such as Epinions™, messaging services such as Twitter™, blogging and news sites such as Engadget™, forums, and other network based services that will now occur to a person of skill in the art. In variations, network services can also be web sites and web services that are associated with or provided by the user account holder. As an example, for a user account that is associated with a charity or a celebrity, associated services information could include web sites associated with the charity or the celebrity. In some implementations network services can be provided by service servers 124. In other variations, network services can also be applications running on a client terminal 104. In variations, these applications can be configured to receive information through the communications interface of the client terminal 104, thus allowing the application to communicate with other computing devices such as provisioning server 124 and service servers 112. In some implementations, the applications may be associated with a web site, a social network or other types of network services. For example, the application may be an application for participating at a social network site.

Services information can include a username and/or other indication of membership or association for each network service identified in the user profile information. Services information can also include associated passwords and/or other security information that can be used in accessing the indicated network services.

Services information can be used in determining distribution scope of messages by provisioning server 112, to network services as will be discussed in greater detail. In some implementations, provisioning server 112 may inject messages in association with user account participation. A user account's participation can take the form of a user account activity at a network service such as posting entries at a social network site, a blog or a short entry such as a Tweet™, or user account presence at a network service such as maintaining a home page at a social network site or maintain one or more web pages at a web site, or interacting with an application. The injection can be done with or without the aid of network services identified. For example, in one implementation, messages such as advertising, branding, promotion, educational or other messages can be provided to a service server 124 to be associated with a user account's activity on a network service provided by that service server 124. The messages provided can be selected by sever 112 based on, for example, specified categories such as likes and dislikes, and their associated values in the user profile information associated with that user account. Accordingly, when that user account posts an entry in a feed, or provides a blog entry, the provided message can be associated with that entry, by for example, displaying the message or an indicator for that message in, on or around that entry. Messages can take the form of text, graphics, icons, images, audio, video and/or a combination of these message modalities and others that will now occur to a person of skill in the art. In other implementations, messages can be provided to be associated with a user account's presence in addition to or in place of user account activity. For example, where a network service is a web site associated with a user account, messages can be associated with the account to be provided at that web site, which in this example is a presence. The locations for providing the messages at the web site may be identified by the user account profile information, or determined at the network service itself, for example. In another example, where a network service is a social networking site or a blogging site, messages can be associated with locations on the user account's home page, namely the user account's presence, as well as account activity such as entries posted by that user account. For example, message content can include a company logo and can be used to replace an account indicator such as the user profile photo in the home page and in account activities. In variations, the logo can include additional indicators indicating that the account endorsed the placement of the logo. Other variations will now occur to a person of skill and are contemplated.

User profile information can additionally include compensation information. Compensation information can indicate user account preferences for payment in return for provision of messages related to that account's participation in the form of activity and presence. This information can include, for example, minimum payment required, the method with which to calculate a payment, and others, which will now occur to a person of skill. Compensation information can vary for each network service identified in the user profile information associated with the account. Compensation information can also vary with the type of participation. For example, compensation required may be higher for activity and presence related to a home page versus activity and presence on other pages. In another example, compensation required may be higher for messages posted on the main page of a web site associated with an account versus sub pages of that web site. In some variations, portions of user profile information can be provided through business accounts such as accounts representing agencies.

It will now occur to a person of skill that user profile information can include additional information that may be used in determining the features and/or functions of provisioning server 112 that can be accessed by or applied to an associated user account. For example, user profile information can include additional information specific to each of the network services specified such as modality of messages that can be distributed to each network service and others. User profile information can be provided through the use of lists from which relevant options can be selected as appropriate as well as through free form information which can be parsed either at a client terminal 104 or at provisioning server 112 to extract the relevant information. For example, categories can be provided in a freeform manner and parsed. Provision of freeform information makes the entry of data more efficient since lists of options do not have to be maintained to cover all anticipated data entry possibilities.

Provision of messages to network services identified in user profile information can be accomplished through communications between provisioning server 112 and one or more service servers 124 responsible for providing the identified network services. To facilitate these communications, provisioning server 112 and/or services servers 124 may include specific APIs and/or interfaces through which service servers 124 and provisioning server 112 can communicate. In some implementations, sometime after a user account receives user profile information that includes services information regarding a particular network service, provisioning server 112 may establish communications with the appropriate service server 124 to inform that particular network service that a user account has included the network service in their associated services information at provisioning server 112. The communications may also include identifying information for the user account for that network service. In variations associated security information for gaining access may also be included. In some implementations, provisioning server 112 can be part of a service server 124.

Once user account information and user profile information is initially provided, a user account can be created as indicated at 215. In some implementations, account creation can cause user account information and included user profile information to be maintained at data store 120. In variations, user account information and associated user profile information can be maintained at client terminals 104 in place of or in addition to maintaining them at data store 120. Where the information is maintained at one or more client terminals 104 as well as data store 120, at least portions of the information may be synchronized. In other implantations, a user account can be created at any time after the entry of user account information. In variations where the provisioning server 112 is part of a service server 124, user profile information may be maintained as part of a user account of the network service provided by that service server 124.

Continuing with method 200, once a user account is created with the associated user profile information, the user profile information can be updated as indicated at 220. The updating can once again be done through the use of a client terminal 104. In one implementation, user profile information can be updated by accessing a user account at provisioning server 112, via a client terminal 104, and updating the information already provided for that account. To access the specific user profile information, user account information such as username and password can be provided to provisioning server 112. In some implementations, the user account information for accessing a user account can be received at a client terminal 104 from a user through the input devices of the client terminal 104 such as a keyboard or a touch screen. In variations, the necessary account information may be stored on the client terminal 104 and thus received from the client terminal 104's data store.

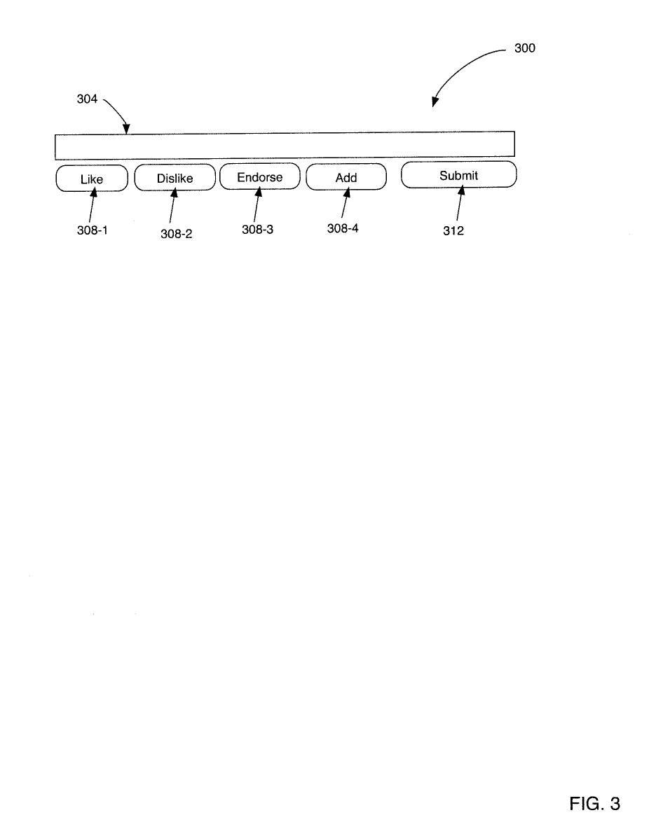

In a variation, a user interface can be provided at a client terminal 104 to facilitate the updating. Referring now to FIG. 3, a non-limiting example interface is indicated at 300. 304 is an entry area that can be used to enter information in text and other modalities. 308-1 through 308-4 are selection items for indicating one or more categories for the entered text. Although in this example interface 300 the list of selectable categories are indicated as selection items, in variations other interface elements such as lists, checkboxes, freeform text that can be typed and others that will now occur to a person of skill can be used and are contemplated. Finally, 312 is a selection item for submitting the user profile information.

Interface 300 can be part of an application dedicated to accessing provisioning server 112, another application such as a browser, a notification bar provided through the operating system or a widget displayed on the main screen of the operating system or other executable running on a client terminal 104 that will now occur to a person of skill. In some variations, an executable can be device agnostic. Once interface 300 is accessed, information can be provided through entry area 304. In variations, the information provided can be text, image, audio, video or other modality or a combination of one or more modalities. As non-limiting examples, text can be typed directly into the entry area 304. Images can be cut and pasted, photos can be inserted through a link to a camera or photo application (not shown), or URLs can be inserted through a link to a browser (not shown). In some variations, messages can be provided to interface 300 based on the information provided through interface 300.

The information entered into entry area 304 can be categorized by selecting one of the selection items 308. For example, selecting selection item 308-1 would indicate that the information entered into entry area 304 should be categorized using the category “like”. In some implementations, the list of selectable categories provided by selection items 308 may be limited, and thus it may be desirable to provide an option for adding additional categories. As a non-limiting example, an additional selection item 308-4 can be provided, which when selected, allows the provision of additional categories that are not expressly provided for as a selection item 308. In some variations, when selecting a selection item 308, the selection item can cause provision of graduated forms of the category indicated by a selection item 308 to allow for a more detailed selection. In further variations, the selection items 308 can be icons instead of text. For example, a thumbs-up can represent likes, a thumbs down, dislikes, and an X can represent “never show”, for example. In further variation, interface 300 can include additional selection items to indicate the modality of the information to be provided such as text, URL, image and others that will now occur to a person of skill.

In variations, categories can be provided as part of the entry area 304. For example information entered can be preceded by a category tag “like”, so that the entry to be categorized can be as follows:

Like: red cars, Toronto.

Like: beaches in general but especially in the Mediterranean.

Dislike: loud concerts, crowded malls.

In variations, the category tag can follow the information. In other variations, indicators other than a colon can identify a category tag. In further variations, selecting one of the selection items 308 can enter category tags into entry area 304. It will now occur to a person of skill that there are various methods of indicating categories through user interfaces, and these are contemplated. In variations, categories can also be converted into hash-tags.

In other variations, information can be provided from applications such as a browser, by selecting at least a portion of the content, and indicating that the selected content belongs to a category. Other variations of indicating information for categorizing from executing applications and content will now occur to a person of skill.

Once user profile information is entered into the entry area 304 and appropriately categorized, the categorized information can be submitted to provisioning server 112. In this example interface 300 the submission action is indicated as selection item 312, and accordingly, selecting selection item 312 will result in the submission of the entered information and categories to provisioning server 112. In variations other interface elements or interactions such as hitting the enter key can be used to indicate a submission action. In some implementations the submission of information to provisioning server 112 may not occur immediately following a submission action, but instead the information may be cached at client terminal 104 for a time period.

Once provisioning server 112 receives the user profile information, the existing user profile information associated with the account that has provided the information is updated accordingly. In some implementations, the information received may be processed, such as by parsing, either at the client terminal 104 where interface 300 is provided, and/or at provisioning server 112. The processing can occur prior to updating the existing user profile information or after. The updating can take the form of replacing and/or augmenting existing information and/or adding to existing information and/or other operations on the information that will now occur to a person of skill in the art.

In one implementation, provision of user account identifying information such as a username and a password can be used to determine the user account whose profile information is to be updated. Once a user account is successfully identified and accessed, the access can be maintained for a period of time, and the user account's user profile information can be updated without requiring subsequent provision of account identifying information during that period. For example, if the account is being accessed through a user interface provided through a web browser, cookies and session information can be used to maintain access to the identified user account on provisioning server 112. Accordingly, providing account identifying information only once would be sufficient to allow adding to user profile information while browsing different web sites through an interface such as interface 300.

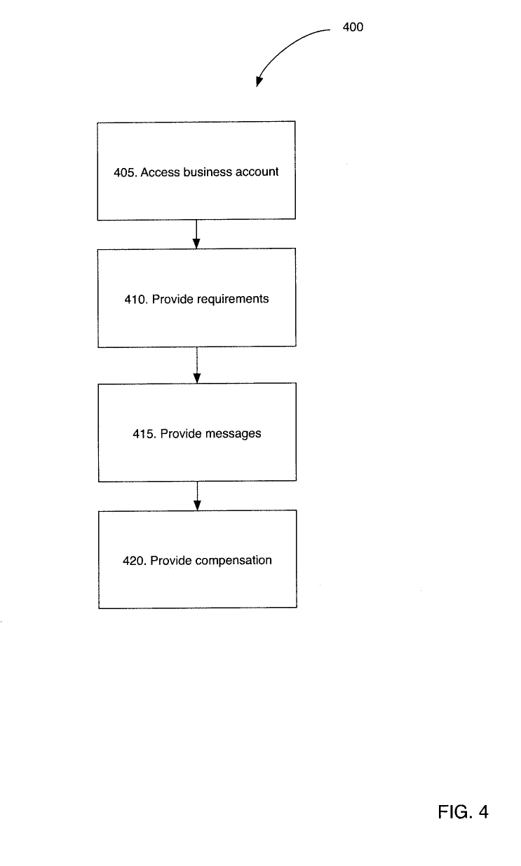

Referring now to FIG. 4, a method for providing a messaging service is indicated at 400. In order to assist in the explanation of the method, it'll be assumed that method 400 is operated using system 100 as shown in FIG. 1. Additionally, the following discussion of method 400 leads to further understanding of system 100. However, it is to be understood that system 100, and method 400 can be varied, and need not work exactly as discussed herein in conjunction with each other, and that such variations are within scope.

Beginning at 405, a business account is accessed at provisioning server 112. A business account is an account that can allow creation and specification of requested messaging services. For example, businesses such as merchants, marketers, promoters, manufacturers, agencies, advertisers and others can specify, through their business accounts, messaging services required to achieve promotion of products, brands, goods and services.

In one implementation, a business account can be created and accessed using a client terminal 104, which can communicate with provisioning server 112 through the network 108. For example, client terminal 104-3, a desktop computer, could obtain a web page provided by provisioning server 112, the web page designed to acquire and forward to provisioning server 112 information necessary for creating and maintaining a business account. In variations, communications with provisioning server 112 can be implemented differently. For example, a client terminal 104 can communicate with provisioning server 112 through an application executing on client terminal 104 which can access network 108. Accordingly, information related to a business account can be received through the application executing on the client terminal 104-3 and can be communicated to provisioning server 112 through the application. In some implementations provisioning server 112 may provide specific APIs and/or interface for communicating with provisioning server 112 for the maintaining a business account. Other methods of communicating with provisioning server 112 to provide and receive information related to a business account will now occur to a person of skill in the art such as accessing provisioning server 112 through servers operated by businesses and such methods are contemplated.

Business account information can include a username, a password, and business account type such as a product provider, a merchant or a marketer. Business account information can also include messaging service requirements. Messaging service requirements can be requirements that determine the reach of the messaging services or campaigns required, such as the number of user accounts to be included, the number of network services to be included and the number of messages to be included in a requested messaging service. Business account information can also include messages to be provided by provisioning server 112 as part of the requested messaging service. Other information that can be included, as part of the business account information such as budgeting requirements, will now occur to a person of skill and are contemplated. In some implementations, multiple messaging services can be requested as part of a single business account, and information associated with those multiple services can be included as part of the business account information for that account. In cases where a user account is associated with multiple messaging services, the number of services a user account can be involved with can be limited by provisioning server 112 and/or by requirements specified by business account information and or by user profile information.

In some implementations, business account information can be maintained at data store 120. In variations, business account information can be maintained at client terminals 104 in place of or in addition to maintaining them at data store 120. Where the business account information is maintained both at one or more client terminals 104 as well as data store 120, at least portions of the information may be synchronized.

Continuing with method 400, at 410 requirements for the messaging services or campaigns desired are provided. In one implementation, messaging service requirements can specify user account requirements that form the basis of selecting the user accounts to be associated with (for example, included in or excluded from) a requested messaging service. In these cases, the reach of a messaging campaign can be determined, at least in part, on the basis of user account information. For example, messaging service requirements could specify that only user accounts that indicate certain user profile information categories, certain keywords and other user profile information characteristics should be included. The specification of messaging service requirements can be done broadly, such as inclusion of all user accounts that include music as part of their user profile information, or can be done more granularly, such as by specifying more specific requirements. For example, as part of a campaign to promote a band Alty, messaging service requirements can specify inclusion of user accounts which include in their profile information a category “like” for alternative rock and music. In addition, the same business account's messaging service requirements can specify excluding user accounts with profile information that include a category “dislike” paintings. Moreover, the messaging service requirements for that business account can further specify inclusion of the name or keyword “Alty” in the user profile information text. Additionally, the requirements for that business account may specify that user accounts include a specific location such as Toronto and New York as part of their user profile information. Other methods of specifying messaging service requirements on the basis of user account profile information will now occur to a person of skill and are contemplated.

In some implementations, as messaging service requirements are specified, the number of user accounts that would be included as part of the messaging service based on specified requirements can be indicated as part of the reach of the campaign. In variations, the provided number of user accounts to be included is an estimate until confirmation of inclusion can be obtained from individual user accounts for each messaging service requested. The confirmation can be obtained in the form of opt-in or opt-out methods, for example. In some variations, the confirmations can be automatically generated based on the user profile information associated with a user account such as values associated with categories such as like and dislike. Accordingly, a user account can automatically accept to participate in a campaign regarding the band Alty, if that band is indicated as a value for the like category.

The messaging service requirements included as part of the business account information can also specify requirements for network services that specify the network services to be included in or excluded from a requested messaging service. For example, messaging service requirements for the band Alty's tour can specify music blogs, music news sites, music web sites and music applications as the network services to be included, and all social networking services to be excluded. The specification of such requirements can be done broadly, such as all music related services, or can be done more granularly, such as specifying the specific network services.

As it will now be understood, by adjusting the granularity of the messaging service requirements, highly refined messaging campaigns can be created which target specific services and user accounts, allowing targeted messaging services to be specified which are efficient in network resource usage.

The messaging service requirements can also include actual messages and the number of times the messages are to be provided as well as/or their duration as part of the requested messaging service. The messages can differ in both content and/or modality. In one implementation, different messages can be indicated for provision to different user accounts, as determined on the basis of user profile information. For example, one message may be provided to user accounts indicating location Toronto in their profile information, and another message to those indicating New York. Different messages can also be indicated for provision to different network services. For example, text messages can be indicated for blog sites, and multi-media messages for video streaming sites. In other variations, the content of the message can be tailored on the basis of user profile information or user account presence or activity. For example, if a user account indicates a like for red cars, content featuring red cars can be prioritized. Alternatively, if a user account indicates a dislike for hard rock, content regarding hard rock would be excluded. As a further example, if a post includes “Let's plan a lunch date”, a message regarding a restaurant can be provided. As an additional example, a user account may indicate a dislike of animated messages, thus deprioritizing provision of messages with such modalities.

In some variations, the content provisioned can be based on user profile information of user accounts, which are members of a campaign, as well as or in addition to user accounts that are accessing the provisioned messages. For example, a user account A may join a campaign for the band Alty. Messages provided can be prioritized on the basis of user profile information of user account A such that they include content that relates to cats and dogs, such as the band Alty's pictures with cats or dogs. However, when user account B is accessing messages provided through user account A's activity such as comments posted by user account A, the messages can be further prioritized to not show messages involving cats if user account B's user profile information indicates that user account B dislikes cats. Accordingly, different users may view different messages (and numbers of messages) while accessing the same post with which a message is associated.

It should be noted that although the examples so far used categories of like and dislike, more graduated categories can be included to indicate like and dislike. For example, categories must include, love, like, dislike, hate, no-way can be used which would indicate degrees of prioritization of message content or campaigns. For example, messages including content which was categorized as no-way would never be provided for that account, and any content provided would have to include anything specified in the must category. On the other hand content categorized as love would be prioritized over like. In variations, some categories can be treated as permission or lack of permission to be included in a campaign or to have messages provided. In some variations, the messages can be automatically chosen by the system based on user profile information associated with an account. In other variations, confirmation can be obtained for each or some of the messages, based on for example user profile information. Confirmation can include manual opt-in or opt-out by the user account for a given message. For example, a message with content in a dislike category can be forwarded to a user account for confirmation of inclusion or rejection. Other variations will now occur to a person of skill and are contemplated. The number of campaigns a user account can participate in can be based on user profile information. For example, the larger number of category values such as likes and dislikes a user profile provides, the more campaigns a user can take part in. Alternatively, the number of campaigns a user account can participate in can be based on the amount of presence and activity a user account has. For example, the more postings in a third party service a user account makes, the larger number of campaigns it can participate in.

The number of messages to be delivered and/or their duration can similarly be specified on the basis of user account information and/or network services and/or other system characteristics. The duration can be specified in terms of seconds, minutes, hours or days, for example, indicating how long a message is to remain in a user account's activity or presence. For example, a user account's profile picture at a third party service can be changed to a business logo for one day. In variations, if there are multiple messages to be provided in association with a user account activity, the requirements can specify proportions of provisioning for each message, such as displaying one message for 80% of the user account activity and a second message for 20% of the user account activity. As it will now occur to a person of skill in the art there are various methods for determining how to vary message contents, characteristics and numbers on the basis user account information, historical information and network services and these are all are contemplated. If a user account participates in multiple campaigns, the messages associated with different campaigns can be provided simultaneously, or rotated between different campaign messages. For example, a message associated with the first campaign is displayed for one day, and a message associated with the second campaign the second day. In some variations, a conflict may arise if messages with invariable timing from different campaigns coincide. In such cases, a user account can get a notification of conflict. The notification may include option to enroll in another campaign, or to withdraw from the campaign, or to join the campaign at a later date.

In some variations, the total number of user accounts to be included may not be determined until a predetermined date predating the campaign launch or on launch date itself. If, at that date, a predetermined number or percentage of the potential user accounts which otherwise satisfy the campaign criteria are conflicted out due to timing issues (such as enrolling in a campaign that has message timing requirements that conflict with the new campaign), the new campaign may be delayed to recruit the additional conflicted user accounts. In these cases, user accounts may be provide an option to reserve the new campaign dates to prevent them from enrolling in conflicting campaigns sometime later. In some variations, the number of campaigns a user account can participate in can vary based on the user profile information provided. For example, the greater number of likes and dislikes values provided by a user account, the larger the number of campaigns that can be participated in by that user account.

An additional component of messaging service requirements can be budgeting requirements for a requested messaging service. Budgeting requirements can include maximum or minimum cost amounts both broadly and/or granularly. For example, a maximum and/or minimum total cost can be specified for the requested messaging service. Alternatively, cost ranges can be specified for each user account included, for each network service included as well as for categories such as for all users accounts indicating Toronto as a location or for network services not associated with music. As it will now occur to a person of skill in the art there are various methods for specifying budgeting requirements on the basis user account information and network services and these are all are contemplated.

The costs for a requested messaging service can be determined using various methods. For example, there could be different base costs associated with using different network services. These base costs could then be added to a cost calculated on the basis of the number of user accounts included. In some implementations, the cost per user can vary based on user profile information of a user account. The costs per message sent can also be added up for the number of messages sent and included in the total cost. The cost for each different type of message can also vary, for example based on message modality and/or network service used. Different methods for calculating messaging service costs will now occur to a person of skill and are contemplated.

In some implementations, to meet budgeting requirements, the reach of the campaign can be altered. Accordingly, message services requirements can be varied, such as the type of network services required, the user account requirements and others until budget requirements are met.

Continuing with method 400, at 415 messages are provided as part of the requested messaging service. Accordingly, messages can be provided in relation with the participation in the form of activity and/or presence of the included user accounts at included network services. For example, where an included user account operates a web site, specified messages can be added to specified content locations at that web site. Alternatively, whenever a user posts a comment entry in a forum, a message can be associated with that entry. In some implementations, the message provision can last for a specific period or for a specific number of messages. Other methods for determining the conclusion of message provision will now occur to a person of skill and are contemplated.

In one implementation, messages to be provided at specific network services can be communicated to those network services along with an indication of user accounts at those network services which will be associated with the provide messages. In some implementations, the communication can take place each time a user account has activity. In variations, the communications can occur when a new messaging service begins, or new messages are associated with a user. Other methods of timing communication with networking services to communicate messages to be injected will now occur to a person of skill and are contemplated.

In some implementations, provisioning server 112 can also communicate additional requirements associated with messages or services. For example, a number of times a message can be displayed for an account can also be specified. In variations, where more than one message is associated with a user account for a given network service, proportions of message provision can also be specified. For example, if messages M1 and M2 are to be displayed at a service server 124 in association with a user account's activity, the communications to server 124 from provisioning server 112 can include the requirement that M1 be associated with 20% of the user account activity, and M2 be associated with 80% of the user account activity. In variations, content locations can also be indicated for messages to be provided at such as location on a home page and other locations that will now occur to a person of skill. In some implementations, user account profiles can also indicate a limitation on the number of messages to be provided. In further variations, a portion of the content can be displayed in one location, and another portion in another location.

Continuing with method 400, at 420, compensation can be made. In one implementation, compensation is provided to user accounts on the basis of a compensation criteria such as the number of and type of messages provided. Compensation can be provided in the form of monetary funds, goods, services, discounts and other incentives that will now occur to a person of skill. In some variations compensation is provided with each message provided. In others compensation can be provided periodically, at predetermined time intervals, which may or may not be regular, or at the end of one or more messaging services or campaigns. In variations, compensation can be provided for changed profile or cover page photos, for example. In other variations, these activities may not result in compensation. Compensation can also be based on number of impressions and/or click-through where the message provided includes links to view brand or product information or purchase the product, for example. Compensation can take the form of money, gift certificates, discounts and other remuneration that will now occur to a person of skill. Alternatively, rewards can be in the form of points that can be redeemed.

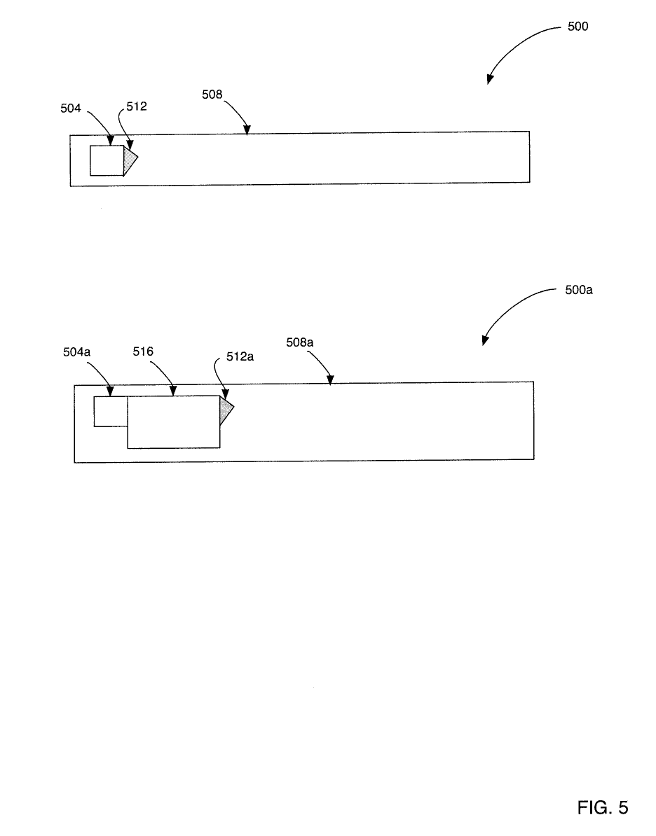

Referring now to FIG. 5 an example entry interface for associating a message with user activity at a network service is indicated at 500 and 500a. Entry 500 indicates the result of a typical activity associated with an entry provided at a comments section of a forum, or a post to a social network feed in accordance with one implementation. For example, image 504 can include an account indicator such as a graphical representation of the user account such as an icon or a picture or animation. Content area 508 can indicate an account user name as well as content for the entry in the form of user comments, for example. Although 504 is indicated as a square in this example, any shape can be used. Indicator 512 provides an indication that a message is associated with this entry. Although 512 is indicated as a triangle in this example, it could take the form of any shape in other implementations. It will now occur to a person of skill in the art that the specific arrangement of entry 500 is presented only for illustration purposes and that in other implementations, the shape, components and arrangement of entry 500 can vary.

Interacting with entry 500, such as clicking on it or any portion of it such as on indicator 512, performing a mouse hover on entry 500 or any portion of it such as on indicator 512 can result in an altered representation of the entry 500 as indicated at 500a. Entry 500a is similar to entry 500 with like components being numbered similarly with the appendage of letter “a”. Entry 500a includes an additional component, a message area 516 which can be revealed based on an interaction with 500. Message area 516 can include contents of the message provided by provisioning server 112, the message being associated, for example, with the user account that posted the entry. In some variations, the altered representation is presented after or as part of an animation. In further variations, the message content, once displayed, can be toggled off through an interaction with visible parts of the entry 500a or the message content 516.

Although in the example entry 500, the content of the message was revealed based on an interaction with an indicator 512, in other implementations at least part of the message content can be included as at least a portion of the indicator 512 prior to any interaction with entry 500. Moreover, indicator 512 can take many different forms and can be located at a variety of locations in relation to the entry 500. For example, an indicator 512 can be located in or around any portion of or the whole of entry 500. Message indicator 512 can be in the form of any shape and color. It can also be in the form of other modalities such as text or audio.

It will now occur to a person of skill that there are a variety of methods of indicating that a message is associated with an entry and also displaying contents of that message in associating with the entry. These are all contemplated. For example, hovering a mouse over an indicator 512 can provide an audio representation of the contents of the associated message. Alternatively, the message content can be provided at a different portion of the display screen, and away from the entry 500. In variations, after an interaction with an entry that includes an indicator, the contents of the message, when revealed, can occlude part of or all of an entry 500, such as covering image 504 with a brand or business logo and other parts of the display screen, including the whole of the output area of the display screen. In other variations, the message can be provided in place of portions of entry 500 such as a brand covering image 504. In some implementations the message can be provided without requiring any user interaction. In further variations, the message contents can be displayed first and upon interaction with the contents of the message, an entry 500 revealed. Some of such variations can include an indicator that the message is associated with an entry. In further variations, messages can be displayed prior to displaying an entry. For example, a video message can be provided prior to playing a video posted by a user account at a video streaming service.

In some implementations, indicator 512 or message display can also indicate endorsement or otherwise approval of the message being provided. As described above, in some variations, endorsement can be obtained from user accounts in the form of confirmation based on user profile information such as values in categories such as likes and dislikes. In variations, endorsements can be provided through other means. Business accounts can forward endorsement requests to user accounts that would then be completed by the user accounts to indicate endorsements. Endorsement can also be provided in a graduated manner such as strongly or very strongly. In yet other variations, endorsements can be provided through specific portals, apps or other means that will now occur to a person of skill.

In other variations more than one indicator and/or message can be provided. Where multiple indicators and/or messages are provided, they can be presented at various locations in relation to the entry 500. In some variations, multiple indicators can be provided for a single message. In other variations, a single indicator can be used for multiple messages. In further variations, messages and/or indicators can be provided as part of the interface for providing user account profile information such as the example interface 300 indicated in FIG. 3.

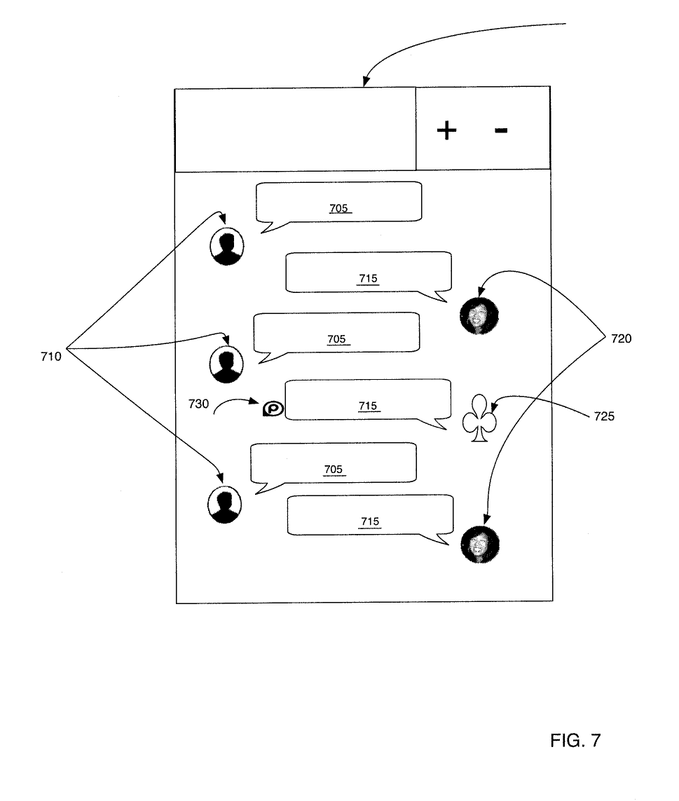

Referring now to FIG. 7, an alternative entry interface for associating a message with user activity at a network service is indicated at 700. The interface can be a messaging application interface, for example. As shown in FIG. 7, a first account, indicated at 710 by the smiling account indicators is exchanging a conversation with a second account 720, indicated by a different account indicator. Entries provided by the first account are indicated at 705, and entries provided by the second account at 715.

It'll be noted that the second account indicator associated with the second entry 715 has been replaced by a company logo 725, which can comprise at least part of the message content to be provided in association with account activity. A message indicator 730 is also shown associated with the second entry 715 of the second user account. Message indicator 730 can simply indicate that second user account is associated with the provisioning server 112. Additionally, it can, similar to message indicator 512, be interactive, and can be interacted with provide additional message content.

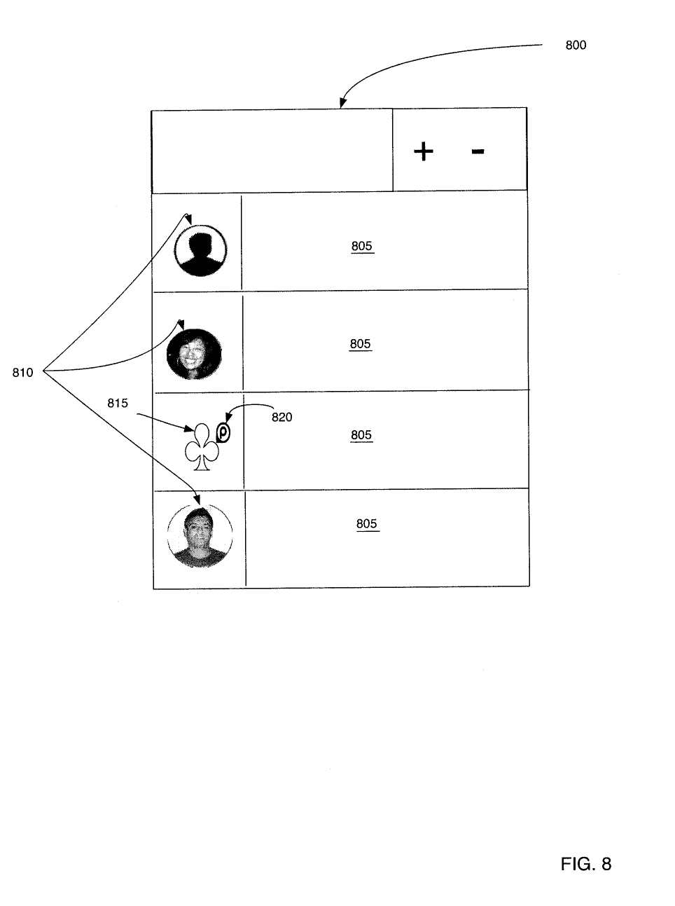

As a further example, referring now to FIG. 8, an alternative entry interface for associating a message with user activity at a network service is indicated at 800. The interface can be an interface for leaving comments, for example. As shown in FIG. 8, four different entries have been posted at 805. Each entry is indicated by a different account indicator 810 identifying the account making the post.

It'll be noted that a third account indicator associated with the third entry 805 has been replaced by a company logo 815, which can comprise at least part of the message content to be provided in association with account activity. A message indicator 820 is also shown associated with the third entry 805. Message indicator 720 can simply indicate that the third user account is associated with the provisioning server 112. Additionally, it can, similar to message indicator 512, be interactive, and can be interacted with provide additional message content.

Although in these two examples, a message is associated with one entry and one account, in variations, one or more additional messages can be associated with other entries and accounts and displayed accordingly. Other variations will now occur to a person of skill.

Message content can take many forms. For example, message content can be in the form of an advertisement, a reward, and offer or branding message in one or more modalities. The message content can also include interactive elements. The interactive elements could allow initiation of purchasing of the advertised products or services, for example. In some implementations, the purchase can be performed through the message or a related widget, without having to go to a website, or website for the product provider, for example. Alternatively, the interactive elements can control access to user accounts or allow the content to be shared with other networking services by posting it on social networking sites, for example. The interactive elements can also allow further broadcasting the message contents through email or other messaging services such as Twitter™.

In some implementations, message content is related to offers to the account with which the message is associated. For example, a user account can indicate in its associated user profile information that “Italian food” is in the “like” category. A business account can subsequently request a messaging campaign for user accounts that include “like” of “Italian food”, and subsequently provide messages for those user accounts, the messages including offers such as coupons to Italian restaurants. The messages can be provided to network services identified in the service requirements information for that business account. In variations, the provided offers would be viewable not only by the user account that participates, but also others viewing the participation.

In variations, the content of the message can be tailored on the basis of user profile information associated with user accounts. For example, multiple user accounts can include, as part of their account information, a suggestion, category or wish for a steak night at prices ranging from $50-$200. Such suggestions or wishes, and other related information in user account profiles can be searchable or otherwise discoverable by business accounts. Based on the information obtained a business account can provide offers in a messaging service that is based on in part the suggestions and wishes identified. For example, a business account may decide to provide a messaging service that includes offers for steak night at $125. Accordingly, user profile information can be used as a marketing survey by business accounts to tailor messaging content, by basing the messaging content of the information identified from user profiles. In variations, business accounts can specify messaging service requirements that are based on user profile information which can be user for determining which user accounts and network services to include and/or exclude. For example, continuing with the previous example of a steak night offer, the message service requirements for the steak night offer at $125 may specify excluding user accounts that include a steak night wish at $75 or less.

In some implantations business profile information can also be included as part of business account information. Business profile information can indicate the goods and services that can be provide by a service and information related top those goods and services. A user account can then discover businesses that provide desired goods and services by searching business account information. Business profiles can include additional criteria, which would be of assistance with searches such as location and other relevant information. In variations, the search can be based on recommendations, number of recommendations or strength of recommendations, which can be associated with a business account. For example, a search can specify to show business accounts, which have received strong endorsements or at least a predetermined number of endorsements (e.g. 10), or endorsements from user accounts which are in with the network of the user account performing the search. A user account's network can be determined based on membership in services offered by service servers 124 such as social network services, or other methods which will now occur to a person of skill.

In variations, Business profile information can also be used in provision of messages. In one implementation, user account activity in relation to which messages are to be provided can be browsing. A browser on client terminal 104 used for browsing web sites could be updated, through add-ins or other mechanisms, to facilitate messaging provision.

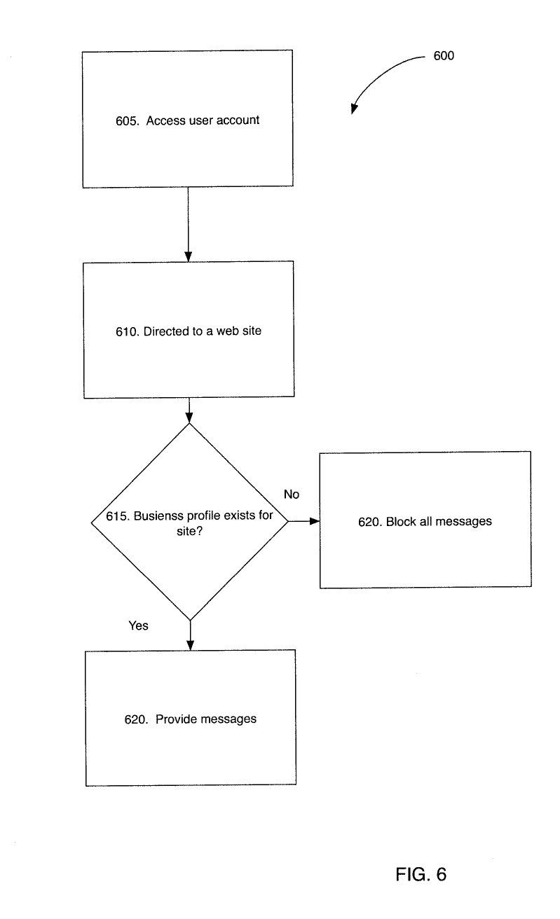

Referring now to FIG. 6, a method for providing a messaging in accordance with business profiles is indicated at 600. In order to assist in the explanation of the method, it'll be assumed that method 600 is operated using system 100 as shown in FIG. 1. Additionally, the following discussion of method 600 leads to further understanding of system 100. However, it is to be understood that system 100, and method 600 can be varied, and need not work exactly as discussed herein in conjunction with each other, and that such variations are within scope.

Referring now to method 600, at step 605, a user account at provisioning server 112 may be accessed through a web browser by logging in for example. The access would then remain active for a certain time period, based on for example cookies and sessions or until logged out from the user account. At 610, the web browser is directed to a web page. Provisioning server 112 could be notified of the identity of the web site containing the web page, and based on the identity, provisioning server 112 could determine, at 615 whether that web site has an associated business account at provisioning server 112. In one implementation, as indicated at 620, all pre-specified advertisement for that web page could be blocked on that web page. In variations only some of the messages could be blocked. If, on the other hand, a business account associated with the determined web site identity is identified, then the associated profile is retrieved at 625, and advertisement is provided for the page based on the business account profile information. The messages can be provided based on a pool of available messages. Alternatively messages can be provided based on user account and business account criteria as described above. In one implementation the business profile information for the business account associated with the determined identity can specify that only a percentage of the advertising space available for that web page can be provided by provisioning server 112, and the rest can be populated through predetermined means by other message providers.

The above-described embodiments are intended to be examples and alterations and modifications may be effected thereto, by those of skill in the art, without departing from the scope which is defined solely by the claims appended hereto. For example, methods and systems discussed can be varied and combined, in full or in part.

1. A method of providing a message at a computing device comprising:
receiving a message content originating at a provisioning server, the message content being selected based on a messaging campaign associated with a user account maintained at the provisioning server; and
providing the message content in association with user account participation at a first network service, the network service being provided by a service server different from a provisioning server.

2. The method of claim 1 wherein the participation is an activity comprising posting an entry in the form of at least one of: an update, a comment, a blog, a chat entry, a feed entry and a short entry.

3. The method of claim 2 wherein said providing further comprises:
displaying a message indicator on or near the activity;
detecting an interaction with the message indicator; and
displaying the message content when an interaction is detected.

4. The method of claim 2 wherein providing the message content further comprises displaying the message content in or within the vicinity of the entry associated with the activity.

5. The method of claim 2 wherein providing the message content further comprises substituting an account indicator associated with the activity with at least a portion of the message content.

6. The method of claim 1 wherein the participation is a network service presence including a web page or a user account home page for the network service.

7. The method of claim 1 wherein the association of the messaging campaign with the user account is based on a user profile specified by the user account, the user profile including at least one of categories, services information and user compensation information.

8. The method of claim 7 wherein the categories are determined based on category information generated in association with past participation, by the user account, in a plurality of network services.

9. The method of claim 1 wherein receiving the message content includes an indication of endorsement.

10. A method of message provisioning by a provisioning server comprising:
maintaining user account profiles associated with user accounts;
maintaining campaign service requirements and messages associated with a messaging campaign;
selecting an included user account from the user accounts, and an included network service, the selection being based on the campaign service requirements and the user account profiles; and
associating the included user account and the included network service with the messaging campaign.

11. The method of claim 10 further comprising:
transmitting at least a subset of the messages for provision in association with a participation of the included user account with the included network service.

12. The method of claim 11 wherein the participation is at least one of activity or presence at the included network services.

13. The method of claim 11 further comprising:
selecting the subset of the messages based on an included user account profile associated with the included user account; and
associating the subset of the messages with the selected user account and the selected network service.

14. The method of claim 10 wherein an included user account profile associated with the included user account selected includes categories, the method further comprising:
receiving category information generated in association with a participation, by the included user account, in a plurality of network services; and
updating the categories based on the received category information.

15. The method of claim 10 wherein an included user account profile associated with the included user account selected includes compensation requirements, the method further comprising:
providing compensation to the included user account after a compensation criteria is met.

16. The method of claim 15 wherein the compensation criteria is based on the number and type of messages provided in association with the included user account.

17. The method of claim 11 further comprising:
sending an endorsement request to said included user account;
receiving approval of said endorsement request; and
including and indication of endorsement as part of the transmitted messages.

18. A provisioning server comprising:
a storage device maintaining user account profiles associated with user accounts, the storage device further maintaining campaign service requirements and messages associated with a campaign service;
a communication interface;
a processor connected to said storage device for accessing contents of said storage device, the processor also connected to said network interface for receiving and transmitting communications, the processor further configured for:
selecting an included user account from the user accounts, and an included network service, the selection being based on the campaign service requirements and the user account profiles; and
associating the included user account and the included network service with the campaign service.

19. The method of claim 1 wherein the message content is provided by a business account different from the user account.
